(19) United States
(12) Patent Application Publication
(10) Pub. No.: US 2010/0217726 A1
(43) Pub. Date: Aug. 26, 2010

(54) METHOD AND SYSTEM FOR DISPLAYING CONSUMPTION DATA REPRESENTING CONSUMPTION OF A UTILITY BY A UTILITY CONSUMER

(75) Inventor: Ari John Sargent, Wellington (NZ)

Correspondence Address: BLACK LOWE & GRAHAM, PLLC, 701 FIFTH AVENUE, SUITE 4800, SEATTLE, WA, 98104, US

(73) Assignee: Powershop New Zealand Limited, Wellington (NZ)

(21) Appl. No.: 12/717,831

(22) Filed: Mar. 4, 2010

Related U.S. Application Data
(63) Continuation-in-part of application No. PCT/NZ2007/000380, filed on Dec. 20, 2007.

(30) Foreign Application Priority Data
Sep. 6, 2007 (NZ) 561230

(51) Int. Cl. G06F 17/00

(52) U.S. Cl. 705/412

(57) ABSTRACT

Methods and systems for displaying consumption data representing consumption of a utility by a utility consumer are provided. An example method includes maintaining a plurality of time intervals in computer memory. In an example embodiment, at least one estimated usage value and at least one payment value is calculated. A usage status is determined for one or more of the time intervals based at least partly on the estimated usage value(s). A payment status is determined for one or more of the time intervals based at least partly on the estimated payment value(s) and estimated usage value(s). The utility consumer is presented with individual representations of the time intervals, the time intervals represented so that time intervals having the same status are visually similar and time intervals having different statuses are visually distinct.

### TECHNICAL FIELD

The present disclosure relates to methods, techniques, and systems for displaying consumption data representing consumption of a utility by a utility consumer.

### BACKGROUND

The supply of a utility to a utility consumer premises is an essential service. The consumer uses quantities of the utility during a predefined period. One example of a predefined period is a month. At the end of the predefined period the customer receives a bill from a utility service provider.

The amount of the bill is based on the amount of a utility the consumer premises has used during the predefined period. The bill is often the first notification the consumer receives of the amount of the utility the consumer has used in the preceding time period.

### BRIEF SUMMARY

Embodiments of the present disclosure provide a method, technique, and system for displaying consumption data representing consumption of a utility by a utility consumer or to at least provide the public with a useful alternative.

Techniques of the present disclosure in one form comprise a method of displaying consumption data representing consumption of a utility by a utility consumer, the method comprising maintaining a plurality of time intervals in computer memory; calculating at least one estimated usage value representing the quantity of the utility consumed or expected to be consumed during one or more of the time intervals; calculating at least one payment value representing the payment made by the utility consumer for supply of the utility during one or more of the time intervals; determining a usage status for one or more of the time intervals based at least partly on the estimated usage value(s); determining a payment status for one or more of the time intervals based at least partly on the estimated payment value(s) and estimated usage value(s), the payment status selected from a group of possible payment statuses comprising “fully paid” and “not fully paid”; and presenting to the utility consumer individual representations of the time intervals, the time intervals represented so that time intervals having the same status are visually similar and time intervals having different statuses are visually distinct.

### BRIEF DESCRIPTION OF THE DRAWINGS

FIG. 1 is an example block diagram of an example system environment in which the techniques are intended to operate.

FIG. 2 shows an example display for displaying consumption data.

FIG. 3 is another example display that includes the display of FIG. 2.

FIG. 4 shows an example user interface in which a user is able to update a meter reading.

### DETAILED DESCRIPTION

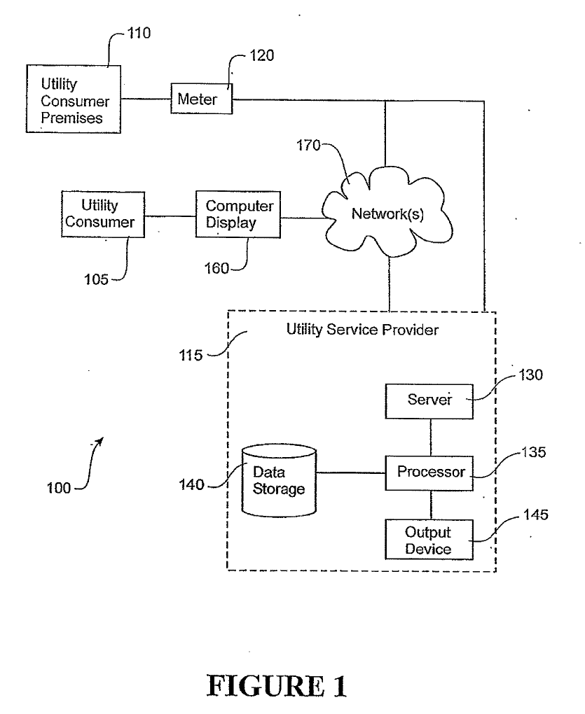

FIG. 1 shows an example block diagram system 100 in which the techniques described below are intended to operate. A utility consumer 105 is associated with a utility consumer premises 110. Premises 110 includes a domestic household, commercial premises, or any other premises to which a utility is supplied. A utility service provider 115 supplies one or more utilities to the utility consumer premises 110. These utilities include provision of electricity, gas and water. The quantities of utility supplied by the utility service provider 115 to the utility consumer premises are typically measured by one or more meters 120. The utility service provider 115 is responsible for delivery of a utility. The provider is a party that has a relationship with the utility consumer for supply of a utility to utility consumer premises 110.

Utility service provider 115 maintains a server 130 interfaced to a processor 135. The processor 135 is in turn interfaced to a data storage component 140 (e.g., a data repository) and an output device 145. The server 130, processor 135 and other components may be maintained at a supplier premises. The server and these components may be implemented by conventional general purpose or special purpose computing systems programmed to provide the functionality described herein. In addition, the services of the utility service provider 115 may be provided as computing instructions stored on a computer-readable storage medium for execution by such a computing system. Other computer-program products may also be made available for implementing the techniques described herein.

Utility consumer 105 makes payment for a supply of a utility. Details of payment are stored in the data storage 140. The utility service provider 115 also maintains usage data representing the amount of utility or quantity of utility consumed by the utility consumer 105 at the utility consumer household 110. Utility consumer 105 has access to a computer display 160. Utility service provider 115 is configured to transmit data to computer display 160 over one or more networks 170. Provider 115 is optionally further configured to transmit data to meter 120 over the network(s) 170, including networks such as wide-area networks or local-area networks. It is envisaged that data is also able to be transferred from meter 120 and computer display 160 over networks 170 to the utility service provider 115.

In order to make full use of the system it is intended that utility consumer 105 is a registered user. A utility consumer signs up as a registered user with a sign up user form. It is envisaged that the form could be paper based or information system (e.g., automatically, or semi-automatically) based. Alternatively the user may sign up using a service provided over a conventional or proprietary telecommunications network. An example is a call center sign up process.

It is intended that the user supplies information about the utility consumer premises. This information enables the utility service provider 115 to make predictions as to expected utility usage of the utility consumer household 110. Information about the utility consumer is typically stored in the data storage 140. The data is available for edit or update by the utility consumer 105 and use of the supplier.

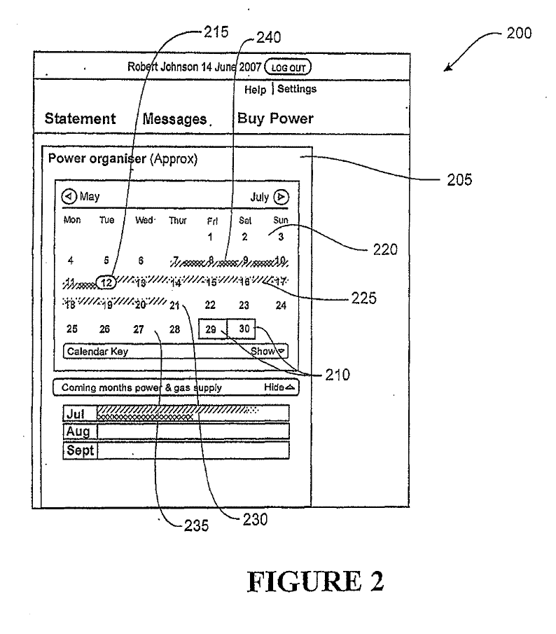

Once the utility consumer has logged on to the system it is expected that the utility consumer 105 is able to view on computer display 160 a display such as that shown in FIG. 2.

FIG. 2 shows an example display for displaying consumption data. The example display 200 displays to the utility consumer what is referred to as a power organiser 205. As shown power organiser 205 includes a plurality of time intervals 210. It is expected that each time interval is of substantially the same length. It is further expected that each time interval represents a calendar day. It will be appreciated that the time intervals could instead represent a different period for example a calendar week or calendar month.

Based on usage data and estimated data, the system calculates respective usage values. These usage values represent the quantity of the utility consumed or expected to be consumed during one or more of these time intervals 210. The system also maintains payment details representing payment made by utility consumer 105 for supply of the utility. The system calculates payment values. The payment values represent the payment made by a utility consumer for supply of utility during one or more of the time intervals.

For each time interval there will be an estimated usage value and a payment value. The system determines a usage status for at least one of the time intervals. The calculation of the usage status is based at least partly on the estimated usage values for each time interval. A payment status is then calculated for one or more of the time intervals based at least partly on the estimated payment value and the estimated usage value for each time interval. These usage statuses include for example “used” and “anticipated to be used”. The payment statuses could include “fully paid” and “not fully paid”. Alternatively the payment statuses could include “fully paid”, “part paid” and “unpaid”.

As shown in FIG. 2, the utility consumer is presented with individual representations 210 of the daily time intervals. The time intervals are represented so that time intervals having the same status are visually similar and time intervals having different stati are visually distinct.

As shown in FIG. 2 a current date is defined on which the power organiser 205 is displayed to a user. The current date 215 is shown as or represented as visually distinct from the remaining representations. One method of showing the representation of current date as visually distinct is to include a border of a suitable size and colour to distinguish it from the remaining representations. It will be appreciated that there are many different ways of making the current date distinct from the representations of the other time intervals. These include, for example, different colors, shapes, font sizes, size of representations, border color and border style.

Those time intervals for which power has been used and fully paid are shown as “used power” 220. Time intervals for which the account has been fully paid and in which the utility is anticipated to be used are represented differently as indicated at 225. There will be some future days for which utility use is anticipated to be used but for which payment values have not been fully paid or part paid. These intervals are indicated at 230 as being a day on which power is “likely to run out”. Further intervals which are anticipated to be used and unpaid are indicated at 235. Time intervals which have been used and not fully paid are indicated in a further colour for example red 240.

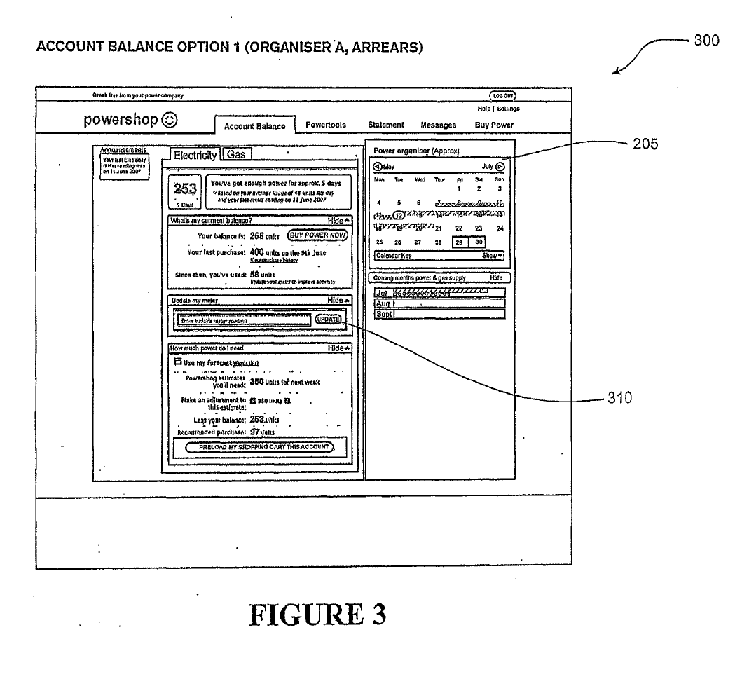

FIG. 3 shows an example user interface that incorporates power organiser 205 and other elements from the display of FIG. 2. The interface 300 includes power organiser 205. The interface further includes an option encouraging the user to update the user meter as indicated in box 310.

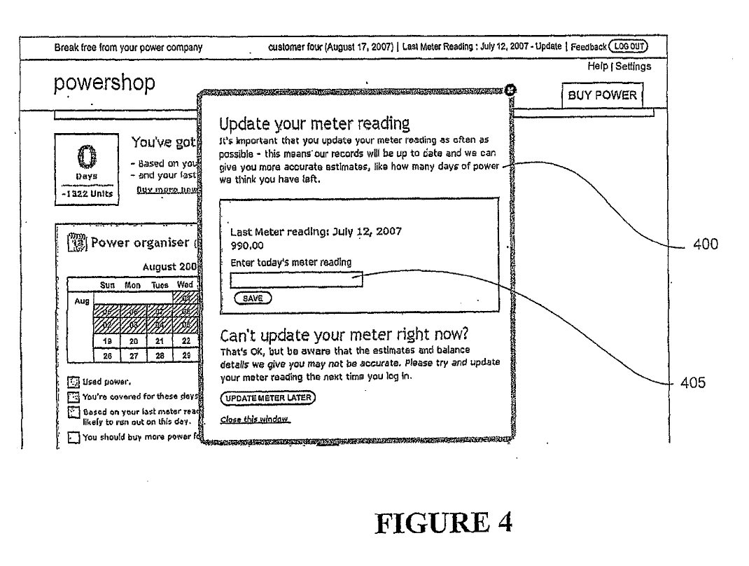

FIG. 4 shows an example user interface 400 in which a user is able to update a meter reading. The user reads the meter and enters the meter in box 405.

From the foregoing it will be appreciated that, although specific embodiments have been described herein for purposes of illustration, various modifications may be made without deviating from the spirit and scope of the present disclosure. For example, the methods and systems for performing the display of consumption data discussed herein are applicable to other architectures other than the displays shown. Also, the methods, techniques, and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A method of displaying consumption data representing consumption of a utility by a utility consumer, the method comprising:
maintaining a plurality of time intervals in computer memory;
calculating at least one estimated usage value representing the quantity of the utility consumed or expected to be consumed during one or more of the time intervals;
calculating at least one payment value representing the payment made by the utility consumer for supply of the utility during one or more of the time intervals;
determining a usage status for one or more of the time intervals based at least partly on the estimated usage value(s);
determining a payment status for one or more of the time intervals based at least partly on the estimated payment value(s) and estimated usage value(s), the payment status selected from a group of possible payment stati comprising “fully paid” and “not fully paid”; and
presenting to the utility consumer individual representations of the time intervals, the time intervals represented so that time intervals having the same status are visually similar and time intervals having different stati are visually distinct.

2. The method of claim 1 wherein determining a usage status comprises selecting a usage status from a group of possible usage values comprising “used” and “anticipated to be used”.

3. The method of claim 1 wherein the group of possible payment values comprises “fully paid”, “part paid” and “unpaid”.

4. The method of claim 1, further comprising defining a current date on which the representations of the time intervals are displayed to the utility consumer.

5. The method of claim 4 wherein the current date is included in one of the time intervals.

6. The method of claim 5 wherein the current date is represented so as to be visually distinct from the remaining representations of time intervals.

7. The method of claim 1 wherein visually similar representations have one or more common elements selected from the group comprising background colour, shape, font size, size, border color, border style.

8. The method of claim 7 wherein visually distinct representations have one or more elements represented differently from the group comprising color, shape, font size, size, border color, border style.

9. The method of claim 1 wherein the time intervals are each substantially the same length.

10. The method of claim 9 wherein the time intervals each represent a calendar day.

11. The method of claim 9 wherein the time intervals each represent a calendar month.

12. The method of claim 1 wherein presenting to the utility consumer comprises displaying the representations on the display of a computing device.

13. The method of claim 1 wherein presenting to the utility consumer comprises printing the representations on a paper medium.

14. A computer-readable memory medium containing instructions that, when executed, cause a computing system to perform a method comprising:
maintaining a plurality of time intervals in computer memory;
calculating at least one estimated usage value representing the quantity of the utility consumed or expected to be consumed during one or more of the time intervals;
calculating at least one payment value representing the payment made by the utility consumer for supply of the utility during one or more of the time intervals;
determining a usage status for one or more of the time intervals based at least partly on the estimated usage value(s);
determining a payment status for one or more of the time intervals based at least partly on the estimated payment value(s) and estimated usage value(s), the payment status selected from a group of possible payment stati comprising “fully paid” and “not fully paid”; and
presenting to the utility consumer individual representations of the time intervals, the time intervals represented so that time intervals having the same status are visually similar and time intervals having different stati are visually distinct.

15. A computing system comprising:
a memory configured to maintain a plurality of time intervals;
a computer processor; and
a presentation component, containing instructions, configured when executed on the computer processor to:
calculate at least one estimated usage value representing the quantity of the utility consumed or expected to be consumed during one or more of the time intervals;
calculate at least one payment value representing the payment made by the utility consumer for supply of the utility during one or more of the time intervals;
determine a usage status for one or more of the time intervals based at least partly on the estimated usage value(s);
determine a payment status for one or more of the time intervals based at least partly on the estimated payment value(s) and estimated usage value(s), the payment status selected from a group of possible payment stati comprising “fully paid” and “not fully paid”; and
transmit to the utility consumer individual representations of the time intervals, the time intervals represented so that time intervals having the same status are visually similar and time intervals having different statuses are visually distinct.
